(19) United States
(12) Patent Application Publication
(10) Pub. No.: US 2018/0260155 A1
(43) Pub. Date: Sep. 13, 2018

(54) SYSTEM AND METHOD FOR TRANSPORTING A DATA CONTAINER

(71) Applicant: Reduxio Systems Ltd., Petah Tiqwa (IL)

(72) Inventors: Jacob CHERIAN, Petah Tiqwa (IL); Nir PELEG, Petah Tiqwa (IL)

(21) Appl. No.: 15/456,621

(22) Filed: Mar. 13, 2017

(51) Int. Cl. G06F 3/06; G06F 12/10

(52) U.S. Cl. CPC G06F 3/0647; G06F 3/061; G06F 2212/65; G06F 3/0673; G06F 12/10; G06F 3/065

(57) ABSTRACT

A system and method for managing a storage system may include storing, recording or including, in a transportable container representation (TCR) a set of unique reference values calculated based on content in a respective set of data elements of a data container. At least some of the unique reference values may be associated with physical locations of respective data elements. Data at specific offsets in the data container may be mapped to the unique reference values. A request for data may be received, the request including a read offset in the data container and the mapping may be used to determine at least one unique reference value. Based on an association of the at least one unique reference with a physical location of a data element, requested data may be retrieved.

### FIELD OF THE INVENTION

The present invention relates generally to transporting data containers. More specifically, the present invention relates to using a transportable representation of a data container.

### BACKGROUND OF THE INVENTION

Transporting or migrating of data containers between storage systems that may be dispersed either within a data center or across geographies has traditionally been a difficult process and is a challenge faced by the computing and storage industry. These data containers may be files, volumes in the case of block storage or any data objects as known in the art. In traditional or known storage systems and methods, the process of data container migration or transportation (e.g., from one machine to another) has been difficult since the definition or representation of data containers includes information about the physical location of data, e.g., addresses of data blocks are included in a representation of, or in an interface to, a logical volume or partition.

For example, a volume as known in the art typically includes a definition of a root structure, a set of pointers to data blocks (associated with a respective set of volume blocks) and the blocks of the actual data. For example, each volume block may be associated with a physical address or location of a data block. This means that to move a volume from one system to another, the definition of the volume and the associated data have to be moved, or the volume structure has to be manipulated during the migration process since at least location information (e.g., physical addresses of data blocks) on a source system that stores the volume may not be valid on a destination storage system, e.g., when moved from one storage system to another, the address (e.g., an offset in a disk address space) of a data block in a volume may, and typically does, change.

Accordingly, prior-art approaches, techniques, systems and methods are limited with respect to transporting data objects such as files and/or storage volumes from one storage system to another.

### SUMMARY OF THE INVENTION

An embodiment for managing a storage system may include storing, recording or including, in a transportable container representation (TCR), a set of unique reference values calculated based on content in a respective set of data elements of a data container. At least some of the unique reference values may be associated with physical locations of respective data elements. Data at specific offsets in the data container may be mapped to the unique reference values. A request for data may be received, the request including a read offset in the data container and the mapping may be used to determine at least one unique reference value. Based on an association of the at least one unique reference with a physical location of a data element, requested data may be retrieved.

An embodiment may include associating each of the unique reference values with a storage system identifier; and if the requested data is not stored by the system receiving the request for data then using the storage system identifier to retrieve the data from a remote system. An embodiment may include receiving, in the request for data, a range of data container offset values; using the mapping to determine a set of unique reference values related to the range; and using the set of unique reference values to retrieve the requested data.

An embodiment may include creating the TCR on a first machine; copying the TCR to a second machine; and using the TCR, on the second machine, to retrieve the requested data. An embodiment may include receiving a data element to be stored in the data container; calculating a unique reference value for the data element; determining a container offset for the data element; and updating the TCR to include a mapping between the data container offset and the unique reference value.

A TCR may represent, or be used for accessing, at least one of: a block storage volume, a file and a data object. An embodiment may include mapping a set of unique reference values to a respective set of data chunks, each data chunk including two or more data elements; and using a unique reference value to retrieve a data chunk. An embodiment may include associating at least some of the unique reference values with two or more storage system identifiers; and selecting a storage system from which to retrieve the requested data based on at least one of: cost, geographic distance and processing load.

An embodiment may include creating, on a first storage system, a TCR; transporting the TCR to a second storage system; receiving at the second storage system a request for a data element included in the data container; using the mapping to determine at least one unique reference value; and based on an association of the at least one unique reference with a physical location of a data element, retrieving the requested data.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of a computing device according to illustrative embodiments of the present invention;

FIG. 2 is an overview of a prior art system;

FIG. 3 illustrates a mapping in a reference based data container according to illustrative embodiments of the present invention;

FIG. 4 shows components and flows according to some embodiments of the invention;

FIG. 5 shows a system and a data structure according to some embodiments of the invention;

FIG. 6 shows a flowchart of a method according to illustrative embodiments of the present invention;

FIG. 7A shows a system and data flows according to illustrative embodiments of the present invention; and

FIG. 7B shows a flowchart of a method according to illustrative embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

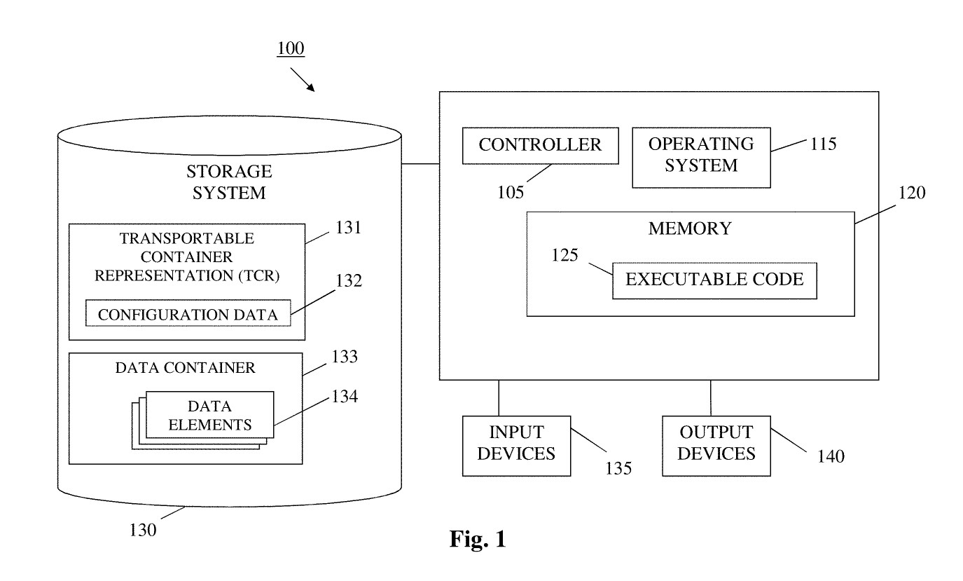

Reference is made to FIG. 1, showing a high-level block diagram of a computing device or system 100 according to some embodiments of the present invention. Computing device 100 may include a controller 105 that may be, for example, a central processing unit processor (CPU), a chip or any suitable computing or computational device, an operating system 115, a memory 120, executable code 125, a storage system 130, input devices 135 and output devices 140. As shown, storage system 130 may include a TCR 131 that may include or have stored therein configuration data 132. As further shown, storage system may include or have stored therein a data container 133 that may include a plurality of data elements 134. Only a single storage system 130 is shown in FIG. 1, however, it will be understood that any number of storage systems similar to storage system 130 may be included in a system according to some embodiments of the invention, for example, TCR 131 may be stored in a first storage system and data container 133 may be stored in a second, possibly remote storage system, e.g., one connected to a remote computer that may communicate with computing device 100 over a network. For the sake of clarity and simplicity, only one TCR 131 and one data container 133 are shown, however, it will be understood that any number of TCRs 131 and data containers 133 may be included or stored in, or connected to a system according to some embodiments of the invention.

Controller 105 (or one or more controllers or processors, possibly across multiple units or devices) may be configured to carry out methods described herein, and/or to execute or act as the various modules, units, etc. for example by executing software or code.

For example, in an embodiment, a first controller 105 (e.g., in a first server or storage system) may include in a TCR a set of unique reference values calculated based on content in a respective set of data elements of a data container; associate at least some of the unique reference values with physical locations of at least some respective data elements and map data at specific offsets in the data container to the unique reference values. The first controller 105 may send or otherwise copy or transport the TCR to a second, possibly remote, server or storage system.

In some embodiments, a second controller 105 in the second server or storage system may receive a request for data, the request including a read offset in the data container; the second controller 105 may use the mapping in the TCR received from the first server or storage system to determine at least one unique reference value and, based on an association of the at least one unique reference with a physical location of a data element, the second controller 105 may retrieve the requested data. Accordingly, some embodiments may include a first controller or computer that causes a second controller or computer to perform its tasks faster and/or more efficiently. For example, using the TCR provided by the first controller in the above example, the second controller may retrieve data or respond to a request immediately, since once a TCR is available on the remote (second) server or machine, operations such as retrieving data or writing data may be readily performed by a controller in the second machine.

More than one computing device 100 may be included in, and one or more computing devices 100 may be, or act as the components of, a system according to some embodiments of the invention.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

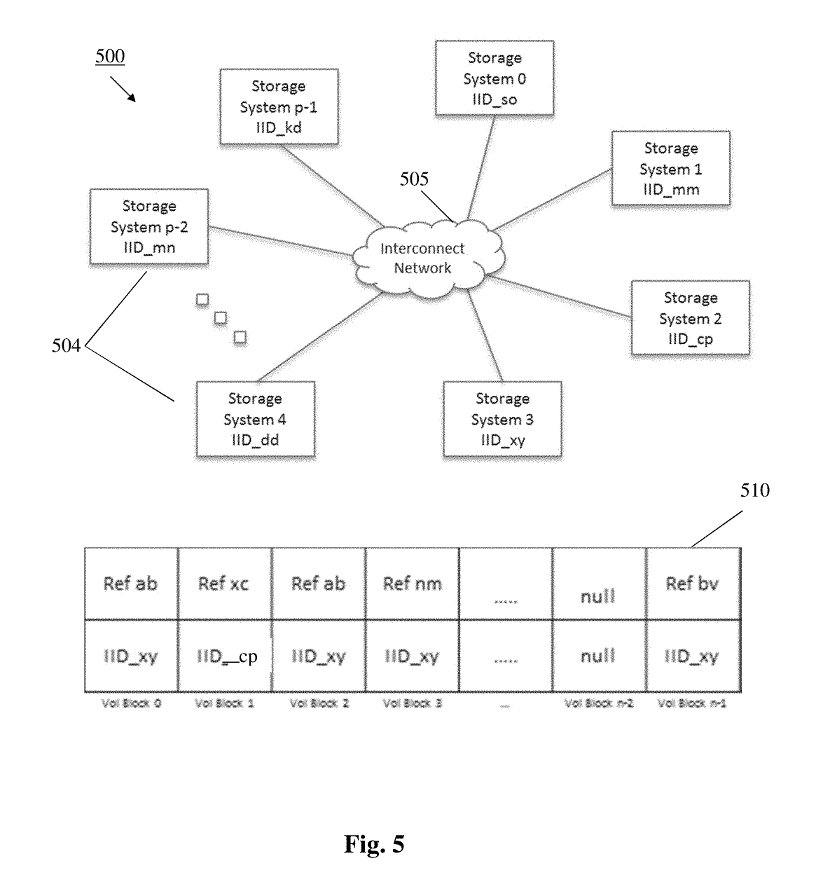

Executable code 125 may be any executable code, e.g., an application, a program, a process, task or script. Executable code 125 may be executed by controller 105 possibly under control of operating system 115. An embodiment may include a plurality of computing devices, storage systems or serves that include a respective plurality of controllers 105 and executable codes 125. For example, a first portion of executable code 125 may be an application that creates, updates and/or maintains a TCR 131 on a first system or machine (e.g. one of storage systems 504 described herein with reference to FIG. 5) and a second portion of executable code 125 may be an application that receives a TCR 131, e.g., on a second, remote system or machine (e.g. another, different one of storage systems 504) and uses the TCR 131 to store and retrieve data on the second or remote system as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Storage system 130 may be or may include, for example, a hard disk drive, a Compact Disk (CD) drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. For example, TCR 131 or configuration data 132 may be loaded into memory 120 where they may be updated, modified and/or used by controller 105 as described herein. Storage system 130 may be directly connected to computing device 100 or it may be otherwise operatively connected to computing device 100, for example, a first storage system 130 that includes TCR 131 may be connected to computing device 100 using a data bus as known in the art and a second storage system 130 that stores or includes data container 133 may be connected to computing device 100 over a network.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer, a universal serial bus (USB) device or external hard drive may be included in input devices 135 and/or output devices 140.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 100.

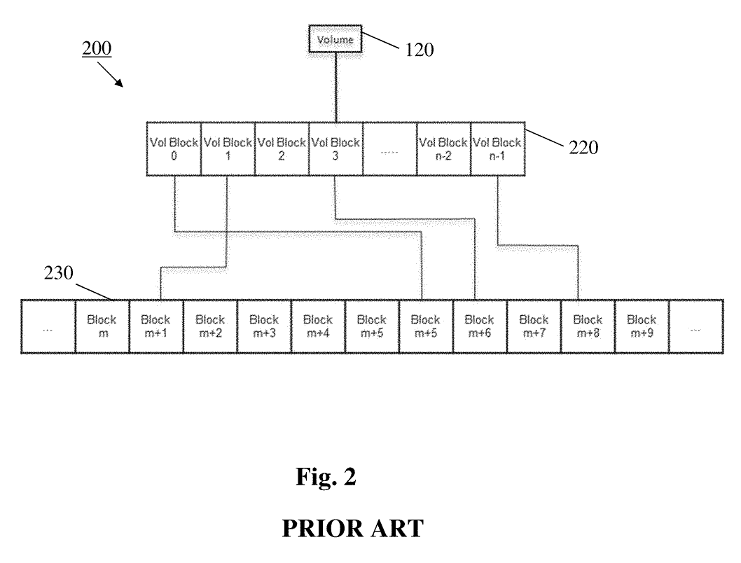

Reference is made to FIG. 2, an overview of a prior art system 200. As shown, in prior art or traditional systems and methods, a data container 120 (e.g., a volume) may include a set of references, pointers or offsets 220 that map locations, offsets or blocks of the data container to physical blocks or elements of data 230. For example, pointers 220 may be values in an array, table or list and data elements 230 may be data blocks in a hard disk. For example, in response to a read request of volume block 3, system 200 may provide the data element or block m+5 since, as illustrated by the line connecting volume block 3 and data element or block m+5, volume block 3 may be, or may include, a pointer to block m+5.

Data container 120 with its pointers 220 and data elements 230 is not transportable. For example, the set of pointers 220, created on a first storage system that uses a first storage device (e.g., hard drive) may be useless or invalid if transported to another storage system that uses a second, other storage device, since pointers 220 include, represent, or point to, specific addresses (or physical locations) of data elements on the first storage device and the addresses (or physical locations) of the data elements on the second storage system may be different from those in the first storage system.

Some embodiments of the invention may include a transportable container representation (TCR) that may enable transporting or migrating a data container from one storage system to another while maintaining the validity of data in, or of, the TCR and the data container. In some embodiments, a TCR may include globally valid, or unique, references to data elements in a storage system, e.g., references in a TCR may be valid and/or unique in a system that includes a set of storage systems, e.g., a set of servers or databases in an organization.

Generally, in some embodiments, a TCR may be disconnected from its data. In some embodiments, instead of, or in addition to, including actual data and/or pointers to actual or physical addresses of data elements, a TCR includes references (to data elements of, or in, a data container) that are globally valid among a plurality of storage systems. For example, using unique reference values associated with, or mapped to, physical locations and specific offsets in a data container, a data container such as a volume, file or other data object (e.g., a multimedia or other object) may be migrated or transported from a first storage systems to a second, e.g., remote storage system.

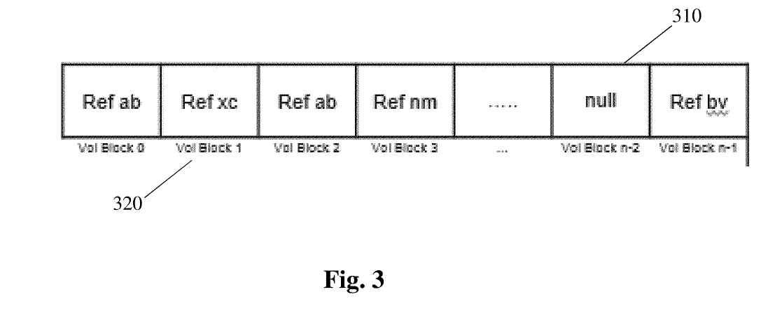

Reference is made to FIG. 3, which shows a mapping in a reference based data container, e.g., a TCR, according to illustrative embodiments of the present invention. As shown, a set of unique reference values 310 may be calculated for a respective set of data elements of, or in, a data container. A unique reference value of the actual content, e.g., unique reference values 310, may be calculated or generated by means of a cryptographic hash or any other mechanism that ensures that for each data element or block in a data container (e.g., each of data elements 134 in data container 133) the unique reference value is unique across a set or plurality of storage systems. The value may be unique within a specific instantiation of the invention, but not be unique when compared with the universe of numbers of data stored on all existing computer systems.

As shown, data elements, blocks, or other data units or offset 320 in TCR may point or be mapped to, or may be associated with, unique reference values 310. For example, each one of objects 320 in a TCR may point to, may represent or may reference, a unique reference value in unique reference values 310. Accordingly, an embodiment may include a mapping between offsets or addresses in a data container and unique reference values, e.g., receiving an offset value or other address of a data element in a data container, an embodiment may readily determine the unique reference value of the data element. Any system or method for mapping data at specific offsets in a data container to unique reference values may be used. For example, configuration data 132 in TCR 131 may include a list, linked list, table or any other construct that maps or associates offsets in data container 133 to unique reference values calculated for data elements 134, e.g., given an offset 320 in TCR 131 such as shown by “vol block 1”, using a table or list, the respective unique reference value of “xc” may be determined or known. Accordingly, embodiments of the invention may include a mapping of specific offsets in a data container to unique reference values.

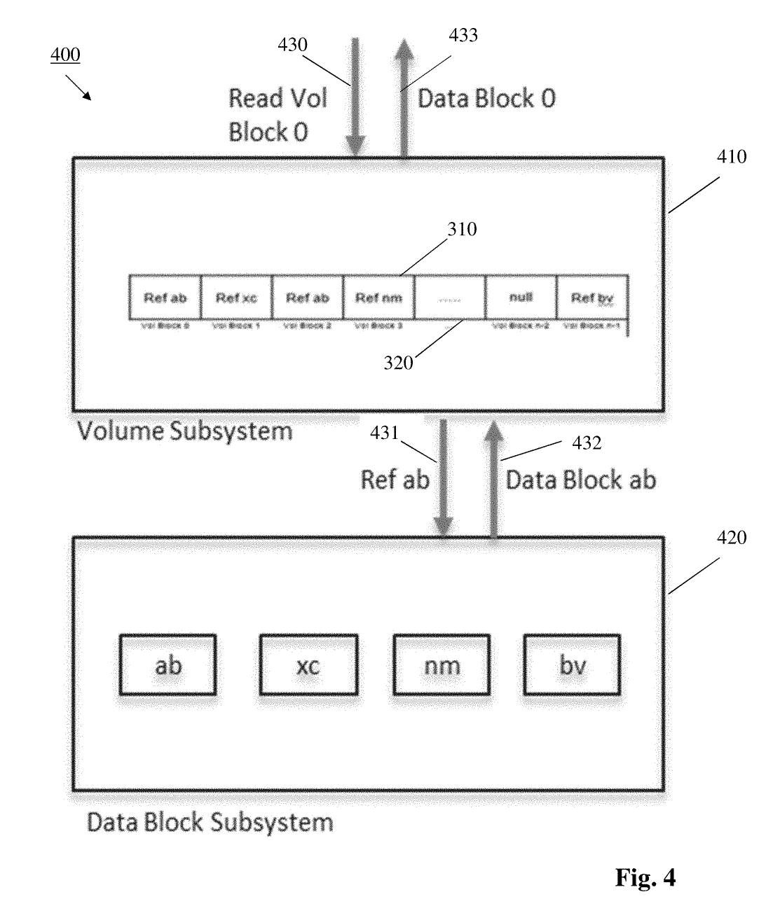

Reference is made to FIG. 4, which shows components and flows of a system 400 according to some embodiments of the invention. As shown, an embodiment (e.g., TCR 131 and configuration data 132) may include a volume (or data container) sub-system 410 and a data block sub-system 420. Sub-system 410 and a data block sub-system 420 may be any unit or module, e.g., each of these units or modules may be, or may include, components of computing device 100, e.g., sub-system 410 and a data block sub-system 420 may be or may include a controller 105, memory 120 and executable code 125.

Volume sub-system 410 may include a mapping (e.g., in memory 120 or in storage system 130) of offsets or references in a data container to unique references as shown by offsets 320 and unique reference values 310 that may be included in volume sub-system 410. For example, volume sub-system 410 may provide multiple storage systems, hosts or clients with a view of and/or access or interface to, data elements 134 in data container 133. For example, included in a TCR that is copied to, or duplicated on, a plurality of hosts or machines, volume sub-system 410 may provide the plurality of hosts or machines with access to data elements 134 as if data container 133 is locally stored.

Data block sub-system 420 may access or manage the actual data block (e.g., provide access to physical or actual data elements 134). For example, data block sub-system 420 may include a mapping between unique reference values 310 and physical or actual addresses or locations of data elements 134. Accordingly, given a unique reference value of a data element, data block sub-system 420 may determine the address or location of the data element, e.g., in a hard drive or other storage device or system, and data block sub-system 420 may use the address or location to retrieve the data element or to modify, delete or overwrite the data element or data block.

As shown by arrow 430, to retrieve an element or block of data, system 400 may be queried with a reference to the element or block and, as shown by arrow 433, system 400 may respond with the actual element or block, e.g., system 400 may provide as output the content stored in a physical location based on an input reference.

For example, to read a data element or block (e.g., one of data elements 134) a user or application may issue a read request that includes a reference to, or offset in, a data container, e.g., as input. Volume sub-system 410 may convert an input reference to, or include the input reference in, a query that may be issued to block subsystem 420 (e.g., as shown by arrow 431) and block sub-system 420 may return (as shown by arrow 432) the content or actual data requested. The actual data may be provided as shown by arrow 433.

Writing, deleting or modifying data elements may be done using system 400. For example, to write or modify data in one of data elements 134, an application, user or host may provide, as input to system 400, a reference as described and data to be stored or a reference and a command (e.g., delete) may be provided. The input reference may be used for determining a unique reference as described, the unique reference may be used to determine a location or address as described and the content provided as input may be stored in the location, or a command (e.g., delete or specific manipulation of data) may be performed on the content in the location.

In some embodiments, a single data block subsystem 420 may be used in order to access more than one data container. For example, since data block subsystem 420 uses reference values that may be unique in a system that includes several storage systems that store many data containers, data block subsystem 420 may locate, find or access data elements or blocks of any number of data containers that may be stored on any number of storage systems, e.g., data elements or blocks in multiple volumes may be accessed using the same or a single data block sub-system 420.

Reference is made to FIG. 5, which shows a system 500 and a data structure 510 according to some embodiments of the invention. As shown, in some embodiments, a plurality of storage systems 504 (denoted in FIG. 5 as “Storage System 0”, “Storage System 1”, . . . “Storage System p−1”) may be interconnected by an interconnect network 505. Files and data may be moved or transported via for example a network such as network 505, or via another method. For example, storage systems 504 may be servers, databases and the like and may each include components of computing device 100, e.g., storage systems 504 may include a controller 105, memory 120 and executable code 125 as well as one or more TCR 131 that may represent or be used for interacting with one or more data containers 133. For example, storage systems 504 may be a set of servers or other storage systems, each including, or connected to, one or more hard disks or hard drives where the servers or storage systems are used by an organization to store and/or distribute data. For example, storage systems 504 may be used for providing worldwide access to data of an organization or service by providing, in different geographic locations, access to block storage volumes, files and/or any other data objects or data containers.

Network 505 may be, may comprise or may be part of a private or public IP network, or the internet, or a combination thereof. Additionally or alternatively, network 505 may be, comprise or be part of a global system for mobile communications (GSM) network. For example, network 505 may include or comprise an IP network such as the internet, a GSM related network and any equipment for bridging or otherwise connecting such networks as known in the art. In addition, network 505 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 505 are implied but not shown, e.g., access points, base stations, communication satellites, GPS satellites, routers, telephone switches, etc. It will be recognized that embodiments of the invention are not limited by the nature of network 505.

As shown, for example by IID_so in storage system 0, IID_mm in storage system 1 and so on, each of storage systems 504 may be given or assigned a unique (within a specific embodiment) instance or identification (ID) value or code, e.g., the IDs of storage systems 504 may be unique within system 500 such that no two storage systems included in storage systems 504 are assigned or associated with the same ID value. Accordingly, a specific storage system included in storage systems 504 may be uniquely identified with respect to other storage systems in system 500.

TCRs may be transported, copied or moved to, or duplicated in storage systems 504. For example, a unique reference value as described herein may include, in addition to a unique value calculated based on content, a unique value or ID that uniquely identifies the storage system that stores or includes the content of a data element.

In some embodiments, unique reference values may be associated with storage system identifiers and, if data requested in a first system is not stored by the first system (or by the system receiving the request for data) then a storage system identifier may be used to retrieve the data from a remote or second system.

For example, data structure 510 may be included in a TCR and used as described. As shown by data structure 510, in some embodiments, each data element (e.g., volume block) may be associated with a storage system ID. For example, as graphically illustrated by data structure 510, a table, list or other construct may include or associate, for each data element, a unique references value 310, an offset or logical address in a data container 320, and a unique system ID. For example and as shown, the data element with unique reference value of “ab” may be stored by storage system 3 which has the unique ID of “IID_xy”, the data element with unique reference value of “xc” may be stored by storage system 2 which has the unique ID of “IID_cp” and so on. For example, in the case data container 133 is a volume, TCR 131 may store, for each volume block, a reference for a data block and the system ID of the storage system that contains the volume block, for each block. TCR 131 may be the native representation of a data container (e.g., volume) within a storage system or TCR 131 may be created by the storage system to start the process of data container migration.

In some embodiments, to transport or migrate a data container (e.g., file, volume, a multimedia object and the like) from one storage system to another TCR 131 is copied from the source storage system to the destination storage system. When the receiving or destination system receives TCR 131 it may (e.g., instantly) instantiate a data container representation using the data in TCR 131. For example, based on data in TCR, a software driver or other operating system component may enable users and applications on the receiving or destination system to treat a volume represented by TCR 131 as if it is a real volume from which data can be read and/or to which data can be written.

The actual content (e.g., data elements 134 or volume blocks) corresponding to each reference may be located on, or stored by or in, the destination machine, or if not present on the destination machine, may be retrieved in the background, at a later time or stage (e.g., lazily as referred to in the art), or on demand based on the desired access characteristics for the volume on the destination storage system.

For example, an application on a system that received TCR 131 (e.g., storage system 3) may request one of data elements 134 by sending a request that includes a read offset in data container 133, using a mapping in received TCR 131 (e.g., in storage system p), a unit may determine the unique reference value that corresponds to the read offset and, using a mapping in received TCR 131 as described, the embodiment may determine the physical location of the data element, e.g., the embodiment may determine the system that stores the data element, e.g., identify that the system ID is of storage system p, and the embodiment may determine the location or address of the data element in the system that stores the data element, e.g., an offset in a disk connected to storage system p.

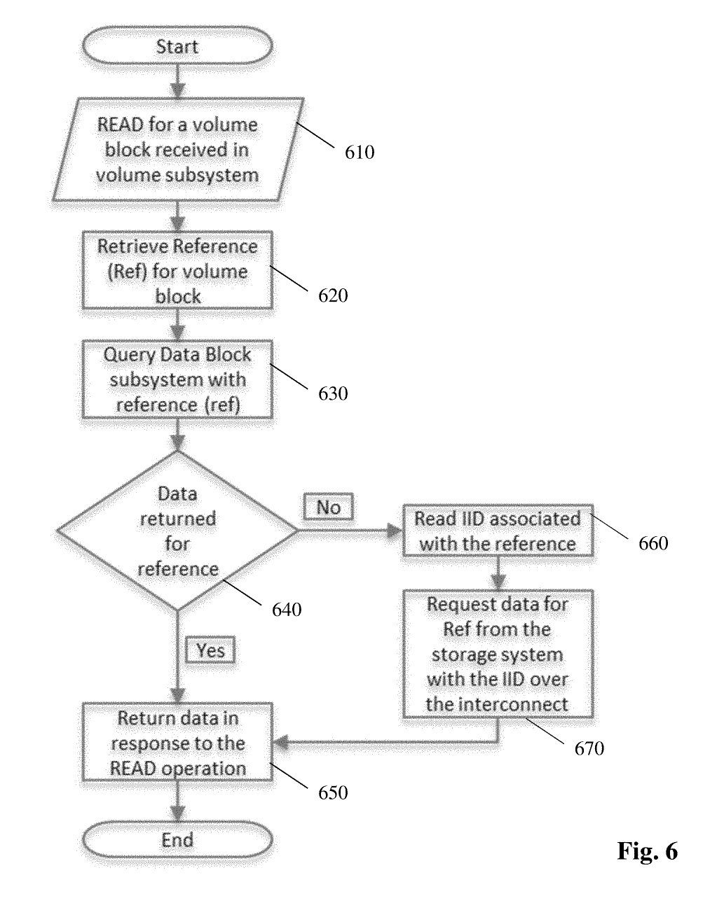

Reference is made to FIG. 6, a flowchart of a method according to illustrative embodiments of the present invention. For the sake of clarity and simplicity, data blocks of a volume are mainly referred to in FIG. 6, however, it will be understood that any data elements other than volume blocks may be used and any data container other than a volume may be used instead or in addition to data blocks and a volume. As shown by block 610, a read request for a volume block may be received, e.g., a read request that includes an offset in a volume may be received by volume sub-system 410 as described.

As shown by block 620, a unique reference value for the requested block may be retrieved, e.g., using a mapping between volume offsets and unique reference values as described. As shown by block 630, a data block sub-system, e.g., data block sub-system 420, may be queried using the unique reference value.

As shown by block 640, an embodiment may check whether or not data for the request may be returned by the local system, e.g., data block sub-system 420 may check whether or not the content of the block requested is stored locally and can be readily provided. If the requested data can be retrieved from local storage then an embodiment may retrieve the data from a local storage, if the requested data cannot be retrieved from local storage (e.g., the actual data element requested is not stored locally) then an embodiment may retrieve the data from a remote storage, e.g., using a system identification in a TCR as described.

As shown by block 650, if the content can be provided from a local storage or memory, then a response that includes the requested data is returned to the requesting entity.

As shown by block 660, if the content is not available locally, e.g., in the case where although the TCR representing a remote volume is present in a the local machine or system but not all actual data or blocks or the remote volume have been copied or moved to the local machine, an embodiment may use the system ID to determine or identify the remote storage system where the content or actual data is stored and, as shown by block 670, a request for the content may be sent to the remote system identified by the system ID and the request may include a reference value that uniquely identifies the content (e.g., the block) on the remote storage system, e.g., one of unique reference values 310. As shown by the arrow connecting blocks 670 and 650, content in a response received from a remote storage system may be provided as described.

It is noted that a TCR enables a data container to be spread over or across several storage systems and still maintain data availability and integrity. For example and as described, a first data block of a volume represented data structure 510 may be stored on storage system 3 and a second data block of a volume represented data structure 510 may be stored on storage system 2. Accordingly, an embodiment may enable virtualization of a data container that includes data elements that are stored in two or more different, separate or geographically remote storage systems.

For example and as shown, the data element with unique reference value of “ab” may be stored by storage system 3 which has the unique ID of “IID_xy”, the data element with unique reference value of “xc” may be stored by storage system 2 which has the unique ID of “IID_cp” and so on. In some embodiments, more than one remote or source system may be listed for, or associated with, a data element. For example, instead of only one system ID as shown in data structure 510, a set of two or more system IDs may be associated with a data element representing a set of two or more storage systems that store or include copies of the content of the data element, accordingly, the content of the data element may be obtained, received or retrieved from any one of the set of two or more storage systems. Any logic may be used to select from which of the set of storage systems to retrieve requested content of a data element, for example, an embodiment may use load balancing. For example, an embodiment may select a storage system from which to retrieve requested data based on comparing the processing load of a set of storage systems. In some embodiment, a storage system for obtaining requested data may be selected based on geographical considerations, e.g., the geographically closest storage system may be selected, in other cases, an embodiment may select to use the most cost effective storage system and so on. It is noted that since the unique reference value may be unique throughout a system, the same unique reference value in a request sent to any of the set of two or more storage systems.

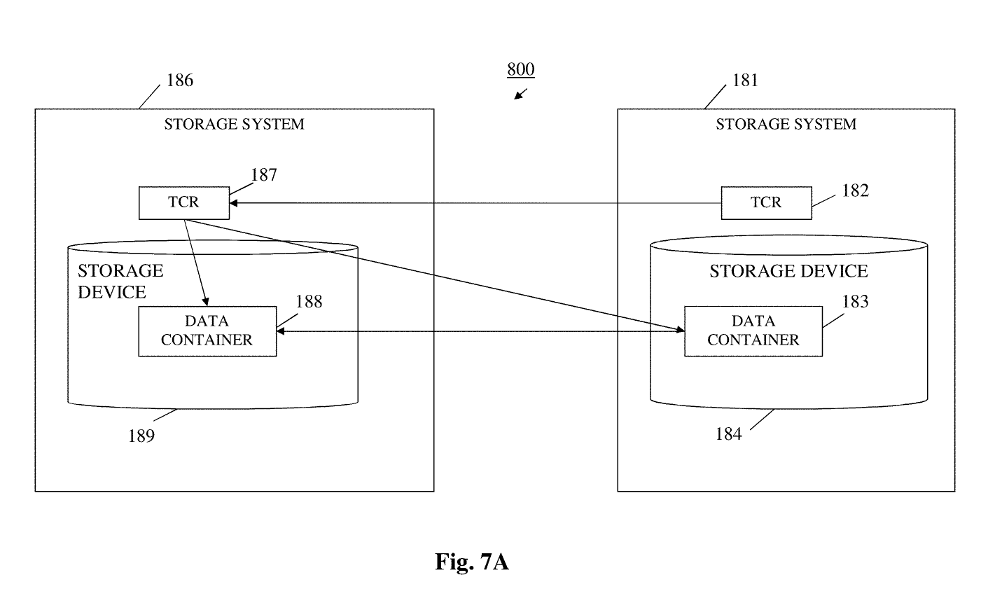

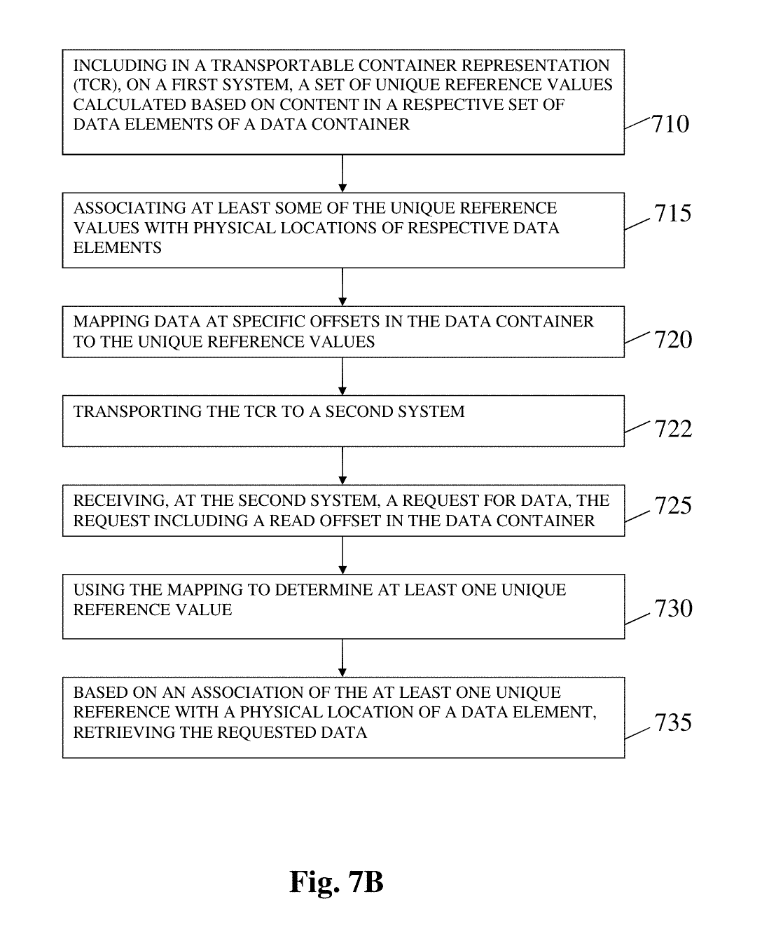

Reference is made to FIG. 7A which shows a system 800 and data flows according to illustrative embodiments of the present invention. As shown, a system may include a first storage system 181 and a second storage system 186. As further shown, storage system 181 may include a storage device 184 that may include a data container 183. TCR 182 included in storage system 181 may be created for example by a controller 105 included in storage system 181 where TCR 182 may be used for accessing data in container 183 as described herein. To enable access to information in data container 183, TCR 182 may be migrated, transported or copied to storage system 186 (that may be a remote system with respect to storage system 181). For example, TCR 187 in storage system 186 may be a copy of TCR 182 that was transported from storage system 181 to storage system 186.

As shown, storage system 186 may include a storage device 189 that may include a data container 188. Data container 188 in storage system 186 may include some, none or even all of the information included in data container 183. As shown, on storage system 186, accessing information in data container 183 may be done via, or using TCR 187. For example, when an attempt to access a data object in data container 183 from storage system 186 is identified or detected, if the data object is included in data container 188 then it may be retrieved and provided therefrom as shown by the arrow connecting TCR 187 and data container 188, otherwise, if the requested or accessed data object is not included in data container 188, an embodiment may retrieve the requested data object from data container 183 as shown by the arrow connecting TCR 187 and data container 183.

In some embodiments, data container 188 may be omitted and any access of information in data container 183 made from, by or via storage system 186 may be redirected to storage system 181. In some embodiments, actual data in data container 183 may be copied to data container 188, for example, data objects in data container retrieved by storage system 186 may be included in data container 188 such that over time, data container 188 include more and more data included in data container 183. At some point, all of the data in data container 183 may be included in data container 188.

The advantages of creating a TCR on a first machine (e.g., creating TCR 182 on storage system 181) and transporting the TCR to a second, possibly remote machine (e.g., transporting TCR 182 to storage system 186 and storing it thereon as TCR 187) will occur to a person having ordinary skill in the art as addressing challenges faced by the industry.

For example, since the definition or representation of data containers (e.g., volumes as known in the art) includes data related to the physical location of data, e.g., root structure, physical addresses of data blocks and the like, to move or migrate a volume or other data container from one system to another known systems and methods have to move or copy the definition of the volume and the associated data have to be moved and/or the volume structure has to be manipulated during the migration process since at least location information (e.g., physical addresses of data blocks) on a source system that stores the volume may not be valid on a destination storage system. This problem may be solved by some embodiments of the invention, for example, by creating a TCR for a data container on a first machine and migrating, transporting or copying the TCR to a second machine. The data container may be immediately accessed, from or by the second machine as described, thus the challenge of accessing local data containers from a remote machine is met and systems, methods and technologies related to data storage are improved. For example, a TCR created for a volume of storage on a first machine may be sent to, and stored in, a plurality of machines (some of which may be remote) and, once the TCR is stored in the plurality of machines, the volume may be immediately accessed by the plurality of machines. It is noted that, unlike known systems and methods that, in order to enable a plurality of remote machines to access a local data container, copy the data container (including its actual data) to the remote machines, an embodiment that includes and uses a TCR as described may eliminate the need to copy an entire data container to the remote machines since, as described, a TCR may enable the remote machines to access (e.g., read from and/or write to) the data container.

Reference is made to FIG. 7B, a flowchart of a method according to illustrative embodiments of the present invention. As shown by block 710, a set of unique reference values calculated based on content in a respective set of data elements of a data container may be included or stored in a TCR in a first system. For example, hash codes or digests may be calculated, by a controller 105 in storage system 181 for data elements 134 data container 183 and the hash codes or digests may be stored in configuration data 132 of TCR 182 in storage system 181.

As shown by block 715, at least some of the unique reference values may be associated with physical locations of respective or associated data elements. For example, TCR 182 may include a mapping of unique reference values to addresses of data elements 134 in a hard drive that may be, for example, storage device 184. As shown by block 720, specific offsets in the data container may be mapped to the unique reference values. For example, TCR 182 may include a mapping of offsets in a volume, file, or other data container to unique reference values that may be calculated based on content pointed to by the offsets.

As shown by block 722, a TCR may be transported, from a first system, to a remote, second system. For example, TCR 182 may be transported to storage system 186 and stored thereon as shown by TCR 187.

As shown by block 725, a read offset in the data container may be included in a received request for data. For example, an application may request a data block at offset 512 in a volume. As shown by block 730, the mapping in a TCR may be used to determine at least one unique reference value. For example, a mapping of volume offsets in TCR 131, e.g., in a volume (or other data container) sub-system 410, may be used to determine or identify a unique reference value based on an offset or address in a data container as described. As shown by block 735, requested data may be retrieved based on an association a unique reference with a physical location of a data element. For example, using data in data block sub-system 420, the physical address of a data block may be found or determined based on the unique reference value of the data element.

As described, an embodiment may include associating some or each of the unique reference values calculated for data elements with a storage system identifier; and if requested data is not stored by the system receiving the request for data then using the storage system identifier to retrieve the data from a remote system. For example, a system ID may be used by a first storage system to identify or determine a second (e.g., remote) storage system that stores the content of a data element and the first storage system may request the data from the second system as described.

In some embodiment, a request may include a range of data container offset values related to a range or set of data elements and, using a mapping as described, an embodiment may determine a set of unique reference values related to the range or set of data elements and use the set of unique reference values to retrieve the requested data elements. For example, a range of data container offset values related to a range or set of data elements may be, for example, offset values 0-1536 that are related, reference, or point to, a set of four data elements stored at offsets or addresses 0, 512, 1024 and 1536.

For example, an application may request 64 data elements having the size of 512 bytes in the address range 512-32,768. In such case, an embodiment may use 64 offsets of the data elements to determine 64 unique reference values, use the 64 unique reference values to find or determine 64 addresses or locations and retrieve the requested 64 data elements using the 64 addresses. It is noted that the addresses may be on, or relevant to, one, two or more different storage systems as described.

Some embodiments of the invention may support requests for reading or writing multiple data elements, e.g., in a single request or command. For example, some embodiments may map a set of unique reference values to a respective or associated set of data chunks, each data chunk including two or more data elements. For example, a data chunk may be, or may include, two or more data elements 134. A set of unique reference values may be used to retrieve a data chunk. For example, a request from volume sub-system 410 to data block sub-system 420 may include a set of unique reference values (related to a chunk of data) and a response from data block sub-system 420 (that may be provided to a user or application as described) may include a chunk of data, e.g., the content in a set of data elements 134.

In some embodiments, a TCR may be created automatically or upon or based on a request or command. For example, if a need to access a volume in a first storage system arises, an embodiment may create, on the first system, TCR 131 by populating configuration data 132 as described (e.g., fill data structures such as 510 or those in sub-systems 410 and 420). After creating a TCR on a first machine, the TCT may be copied to a second machine, e.g., sent over a network and the TCR may be used, in or by the second machine, to retrieve data from the volume. The Data retrieved using a TCR as described may be used for any purpose as known in the art. For example, data retrieved using a TCR as described may be, or may include a file and the file may be examined by a user or application, or data in the file may be processed, or the file may be printed and the like. It will be understood that the scope of the invention is not limited by the usage of data retrieved using a TCR as described.

TCR may further be used, in or by the second machine, to store data in the volume as described. Creating a TCR may include receiving a data element to be stored in a data container, calculating a unique reference value for the data element (e.g., calculate a hash value for the payload or content of a data block), determining or calculating a container offset for the data element, e.g., recording the address or location of the data element in the data container, and updating the TCR to include a mapping between the data container offset and the unique reference value. Determining an offset, reference or pointer may be done as known in the art, for example, a volume as known in the art typically includes a definition of a root structure and a set of pointers to data blocks, accordingly, an embodiment may examine any data of, or related to a volume and determine based on such data offsets or pointers.

Some embodiments of the invention improve the field of storage. For example, by making data containers such as volumes transportable, a storage system may be scaled up easily, something that cannot be done using known in the art systems and methods. Some embodiments of the invention use specific computer data structures (e.g., a TCR) to improve the storage technology, specifically, a TCR used as described may improve access to volumes, files or any other data containers or data elements. For example, by creating a TCR on a first machine and installing the TCR on a second machine, a volume in the first machine may be (quickly) made accessible on the second machine.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method of managing a storage system, the method comprising:
including in a transportable container representation (TCR) a set of unique reference values calculated based on content in a respective set of data elements of a data container;
associating at least some of the unique reference values with physical locations of respective data elements;
mapping data at specific offsets in the data container to the unique reference values;
receiving a request for data, the request including a read offset in the data container;
using the mapping to determine at least one unique reference value; and
based on an association of the at least one unique reference with a physical location of a data element, retrieving the requested data.

2. The method of claim 1, comprising:
associating each of the unique reference values with a storage system identifier; and
if the requested data is not stored by the system receiving the request for data then using the storage system identifier to retrieve the data from a remote system.

3. The method of claim 1, comprising:
receiving, in the request for data, a range of data container offset values;
using the mapping to determine a set of unique reference values related to the range; and
using the set of unique reference values to retrieve the requested data.

4. The method of claim 1, comprising:
creating the TCR on a first machine;
copying the TCR to a second machine; and
using the TCR, on the second machine, to retrieve the requested data.

5. The method of claim 1, comprising:
receiving a data element to be stored in the data container;
calculating a unique reference value for the data element;
determining a container offset for the data element; and
updating the TCR to include a mapping between the data container offset and the unique reference value.

6. The method of claim 1, wherein the TCR represents at least one of: a block storage volume, a file and a data object.

7. The method of claim 1, comprising:
mapping a set of unique reference values to a respective set of data chunks, each data chunk including two or more data elements; and
using a unique reference value to retrieve a data chunk.

8. The method of claim 1, comprising:
associating at least some of the unique reference values with two or more storage system identifiers; and
selecting a storage system from which to retrieve the requested data based on at least one of: cost, geographic distance and processing load.

9. A computer-implemented method of transporting a data container, the method comprising:
creating, on a first storage system, a transportable container representation (TCR) by including in the TCR a set of unique reference values that point to a respective set of data elements in a data container;
associating at least some of the unique reference values with physical addresses of at least some of the data elements;
mapping data at specific addresses in the data container to the unique reference values;
transporting the TCR to a second storage system;
receiving at the second storage system a request for a data element included in the data container;
using the mapping to determine at least one unique reference value; and
based on an association of the at least one unique reference with a physical location of a data element, retrieving the requested data.

10. A system for migrating a data container, the system comprising:
a hardware memory; and
a hardware controller, the controller configured to:
include in a transportable container representation (TCR) a set of unique reference values calculated based on content in a respective set of data elements of a data container;
associate at least some of the unique reference values with physical locations of respective data elements;
map data at specific offsets in the data container to the unique reference values;
receive a request for data, the request including a read address in the data container;
use a mapping of data addresses in the data container to unique reference values to determine at least one unique reference value; and
based on an association of the at least one unique reference with a physical address of a data element, retrieve the requested data.

12. The system of claim 10, wherein the controller is configured to:
associate at least some of the unique reference values with physical locations of respective data elements;
map data at specific offsets in the data container to the unique reference values;

13. The system of claim 10, wherein the controller is configured to:
associate each of the unique reference values with a storage system identifier; and
if the requested data is not stored by the system receiving the request for data then using the storage system identifier to retrieve the data from a remote system.

14. The system of claim 10, wherein the controller is configured to:
receive, in the request for data, a range of data container offset values;
use the mapping to determine a set of unique reference values related to the range; and
use the set of unique reference values to retrieve the requested data.

15. The system of claim 10, wherein the controller is configured to:
create the TCR on a first machine;
copy the TCR to a second machine and wherein a second controller is configured to use the TCR, on the second machine, to retrieve the requested data.

16. The system of claim 10, wherein the controller is configured to:
receive a data element to be stored in the data container;
calculate a unique reference value for the data element;
determine a container offset for the data element; and
update the TCR to include a mapping between the data container offset and the unique reference value.

17. The system of claim 10, wherein the TCR represents at least one of: a block storage volume, a file and a data object.

18. The system of claim 10, wherein the controller is configured to:
map a set of unique reference values to a respective set of data chunks, each data chunk including two or more data elements; and
use a unique reference value to retrieve a data chunk.

19. The system of claim 10, wherein the controller is configured to:
associate at least some of the unique reference values with two or more storage system identifiers; and
select a storage system from which to retrieve the requested data based on at least one of: cost, geographic distance and processing load.
